(19) United States
(12) Patent Application Publication
(10) Pub. No.: US 2010/0151822 A1
(43) Pub. Date: Jun. 17, 2010

(54) Security Protocols for Mobile Operator Networks

(75) Inventors: Gennady Medvinsky, Redmond, WA (US); David E.W. Mercer, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/486,946

(22) Filed: Jun. 18, 2009

Related U.S. Application Data
(60) Provisional application No. 61/122,220, filed on Dec. 12, 2008.

(51) Int. Cl. H04M 1/66; H04W 12/00

(52) U.S. Cl. 455/410; 455/432.1

(57) ABSTRACT

Security protocols for mobile operator networks are described. In embodiments, mobile communication link is established between a mobile phone and a media content provider via a communication service provider with which the mobile phone is registered for mobile communications, and via at least one roaming node network with which the communication service provider has a roaming service agreement. The media content provider receives a security policy request from the mobile phone to establish a security policy for end-to-end security of the mobile communication link between the media content provider and the mobile phone for data communication security. The media content provider then communicates a security policy response to the mobile phone to establish the security policy for the end-to-end security of the mobile communication link that is adaptable to security restrictions of the roaming node network.

### RELATED APPLICATION

This application claims priority to U.S. Provisional Application Ser. No. 61/122,220 filed Dec. 12, 2008, entitled “Security Protocols for Mobile Operator Networks” to Medvinsky et al., the disclosure of which is incorporated by reference herein in its entirety.

### BACKGROUND

Mobile phones and other portable communication devices are increasingly being utilized as network-connected, general purpose computing devices. In addition to traditional features such as voice services and messaging services (e.g., SMS and MMS), new mobile phone features include value added data plans that range from general Internet connectivity for Web browsing and email to multi-media on-demand content delivery, as well as local application data sync to network-based services. While voice and messaging services still form the core business for mobile operators, premium data plans based on partnerships between mobile operators and service providers are emerging as a new, viable business model.

An underlying over-the-air (OTA) network can support authentication, confidentiality, and integrity of a communication channel between a mobile phone and the network of a mobile operator. However, relying exclusively on the security properties of the underlying network can expose vulnerabilities and/or compromise secure data transfers. For wireless mobile roaming, a communication path can include any number of networks based on various roaming agreements, and a communication bridge between a mobile phone and a home network may include or go through any visited or utilized network that the home mobile operator has a roaming coverage agreement. From a security standpoint, any cryptographic protection is terminated at each hop in the communication path. Even in a non-roaming scenario, a mobile operator may include autonomously administered operating companies with a non-uniform set of security practices and procedures, thus being more exposed to data compromise.

Implementing an encrypted end-to-end data channel from a mobile phone to a service provider, in addition to the node-by-node encryption performed by the underlying network can be problematic. In a roaming scenario, and due to encryption regulations in some countries, the data channel between a SIM of a mobile phone and a visited or utilized network is integrity protected only, while the data itself is not encrypted. Thus, end-to-end encryption at a higher or different layer has the potential to leave the mobile operator out of compliance with local encryption laws.

### SUMMARY

This summary is provided to introduce simplified concepts of security protocols for mobile operator networks. The simplified concepts are further described below in the Detailed Description. This summary is not intended to identify essential features of the claimed subject matter, nor is it intended for use in determining the scope of the claimed subject matter.

Security protocols for mobile operator networks are described. In embodiments, mobile communication link is established between a mobile phone and a media content provider via a communication service provider with which the mobile phone is registered for mobile communications, and via at least one roaming node network with which the communication service provider has a roaming service agreement. The media content provider receives a security policy request from the mobile phone to establish a security policy for end-to-end security of the mobile communication link between the media content provider and the mobile phone for data communication security. The media content provider then communicates a security policy response to the mobile phone to establish the security policy for the end-to-end security of the mobile communication link that is adaptable to security restrictions of the roaming node network.

In other embodiments, the media content provider receives the security policy request from the mobile phone and the security policy request includes a region code corresponding to the roaming node network. Alternatively, the media content provider receives the region code that corresponds to the roaming node network from the communication service provider. The media content provider determines an encryption policy for the roaming node network based on the region code, and the security policy response back to the mobile phone includes the encryption policy that is utilized to establish the end-to-end security of the mobile communication link. In an implementation, the security policy request that is received from the mobile phone, and the security policy response to the mobile phone, are included with authentication data messages that are communicated between the mobile phone and the media content provider.

In other embodiments, the mobile phone maintains a cache of encryption policies that correspond to the region codes for various roaming node networks, and the security policy request received by the media content provider from the mobile phone includes an encryption policy for the roaming node network. A security protocol service at the media content provider can receive an indication that the roaming node network is changing to a different roaming node network to maintain the mobile communication link. The security protocol service can then initiate adapting the security policy for the end-to-end security of the mobile communication link for alternative security restrictions of the different roaming node network.

### BRIEF DESCRIPTION OF THE DRAWINGS

Embodiments of security protocols for mobile operator networks are described with reference to the following drawings. The same numbers are used throughout the drawings to reference like features and components:

FIG. 1 illustrates an example system in which embodiments of security protocols for mobile operator networks can be implemented.

FIG. 2 illustrates example method(s) of security protocols for mobile operator networks in accordance with one or more embodiments.

FIG. 3 illustrates example method(s) of security protocols for mobile operator networks in accordance with one or more embodiments.

FIG. 4 illustrates various components of an example device that can implement embodiments of security protocols for mobile operator networks.

### DETAILED DESCRIPTION

Embodiments of security protocols for mobile operator networks provide a security protocol between a mobile phone and a media content provider that conforms to crypto usage policy requirements of a mobile operator network for mobile roaming use. In various embodiments, the security protocol is a higher level protocol that provides end-to-end security from the mobile phone to the media content provider to reduce the exposure of unsecured data. In other embodiments, a mobile operator (also referred to herein as a communication service provider) can securely input connection specific information and other data for delivery to a media content provider via an end-to-end protected data stream.

For monetary transactions, as well as other types of data exchanges, it is in the interest of a media content provider to offer end-to-end security channel guarantees between a mobile phone or other portable communication devices and the media content provider for both over-the-air (OTA) and Wi-Fi (open Internet) data paths. As described herein, OTA refers to data transferred over the Mobile Network Operators mobile data network infrastructure (e.g. UMTS/GSM/CDMA2000) as opposed to connections made over non-MNO networks (e.g. public Wi-Fi hotspots). Wi-Fi is specified in the IEEE 802.11 set of standards.

While features and concepts of the described systems and methods for security protocols for mobile operator networks can be implemented in any number of different environments, systems, and/or various configurations, embodiments of security protocols for mobile operator networks are described in the context of the following example systems and environments.

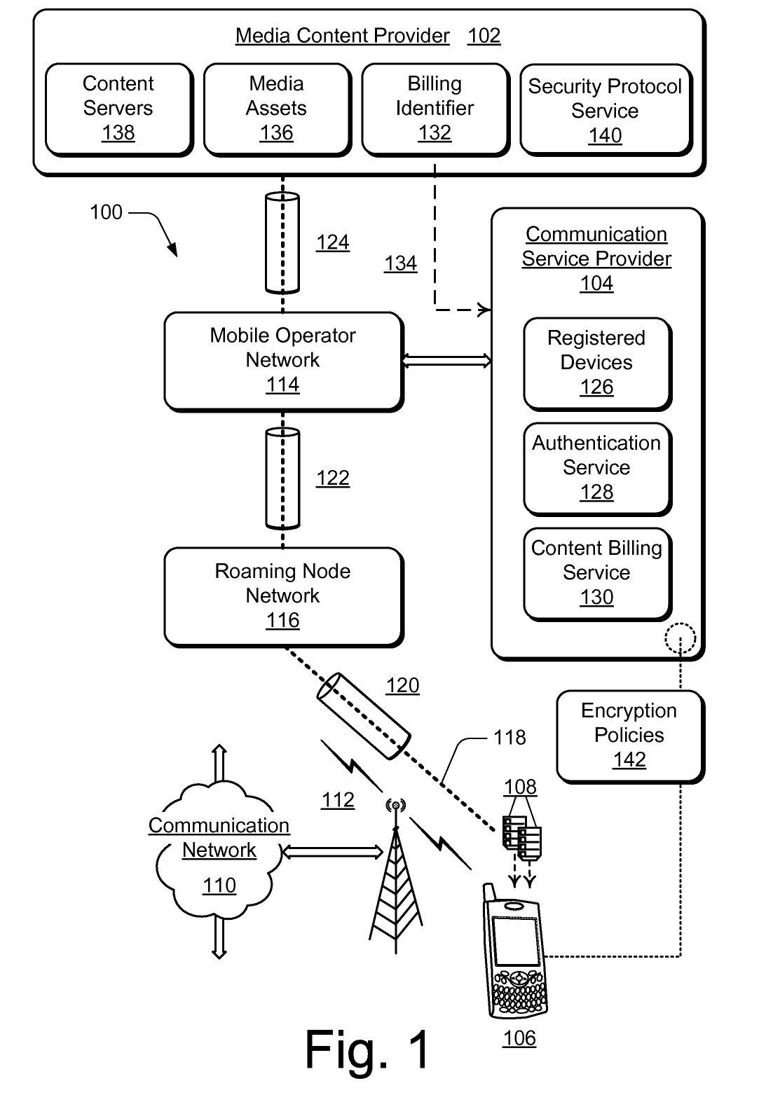

FIG. 1 illustrates an example system 100 in which various embodiments of security protocols for mobile operator networks can be implemented. In this example, system 100 includes a media content provider 102 and a communication service provider 104 that facilitates mobile data and/or voice communications. A communication service provider is also commonly referred to as a mobile operator, and may be a cell-phone provider and/or an Internet service provider. The communication service provider 104 enables data and/or voice communications for any type of a mobile device or mobile phone 106 (e.g., cellular, VoIP, WiFi, etc.), and/or any other wireless media or communication device that can receive data, voice, or media content in any form of audio, video, and/or image data.

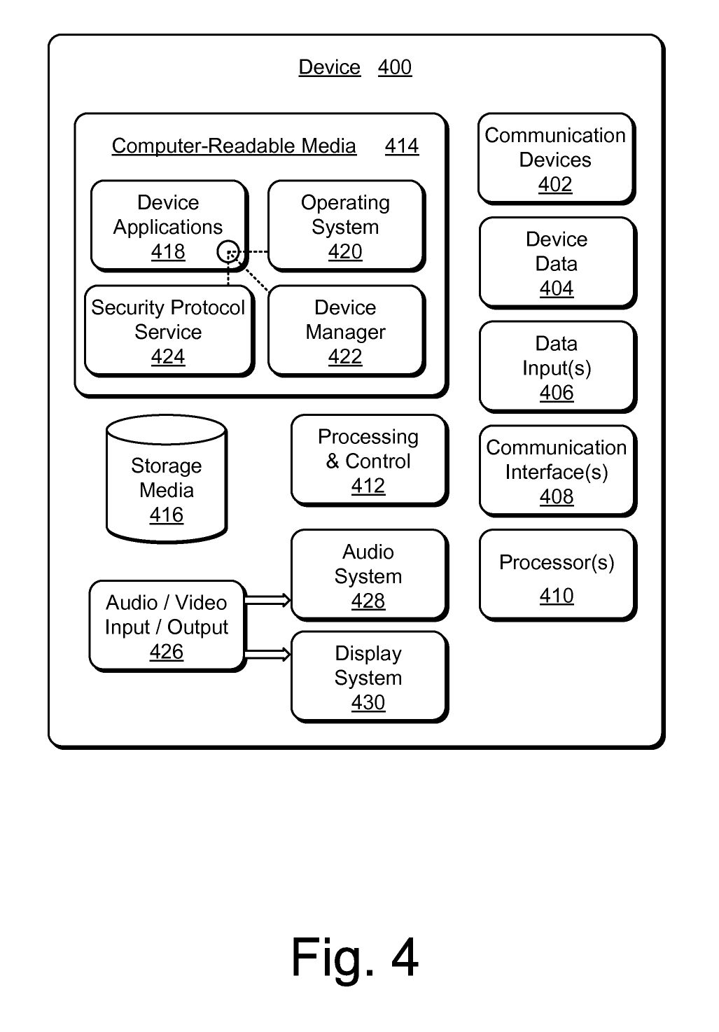

A mobile device (e.g., to include mobile phone 106) can be implemented with one or more processors, communication components, memory components, and signal processing and control circuits. Further, a mobile device can be implemented with any number and combination of differing components as described with reference to the example device shown in FIG. 4. A mobile device may also be associated with a user or owner (i.e., a person) and/or an entity that operates the device such that a mobile device describes logical devices that include users, software, and/or a combination of devices.

The mobile phone 106 can include or have any number of associated Subscriber Identity Modules (SIMs) 108. By way of an example, a user that is associated with mobile phone 106 has a subscription-based relationship with a mobile operator (e.g., the communication service provider 104). In an implementation, the mobile phone 106 is a GSM phone that is utilized with the different SIMs 108. A SIM is a temper resistant smartcard that maintains a unique identifier, such as an International Mobile Subscriber Identity (IMSI) and a cryptographic key (referred to as a K).

For each SIM, the mobile operator maintains a corresponding record in a data store that includes the IMSI to K mapping. The SIM can perform cryptographic operations on the card (i.e., signing, hashing, RNG, encrypt/decrypt), and can implement a security protocol with the mobile operator without the K leaving the SIM, and by using the mobile phone for pass-through of messages. The mobile phone itself is a computer device that can execute an operating system with networking capabilities, such as OTA (over-the-air) and/or Wi-Fi, along with Internet protocol stack support (TCP/IP, HTTP, HTTPS, etc.).

The user that is associated with mobile phone 106 may also have a relationship with the media content provider 102, and a user identity and corresponding security credentials are issued by the media content provider, or by a third party identity provider that is trusted by the media content provider. Using the mobile phone 106, the user can authenticate to the media content provider and purchase media assets and/or services (e.g., download to own a movie, a digital music file, and the like). The authentication credentials may persist on the mobile phone 106 and can take any number of forms, including: user name and password; public key based certificate and corresponding private key; and/or a one time password. Furthermore these credentials may be combined with other form factors (e.g., Biometrics) for added security. These credentials can also be utilized when generating billable events, and can be selected based on their security characteristics.

A communication network 110 can be implemented to include any type of a data network, voice network, broadcast network, an IP-based network, and/or a wireless network 112 that facilitates data and/or voice communication between the media content provider 102, communication service provider 104, and mobile phone 106. In this example, the communication network 110 includes a mobile operator network 114 that is managed by the communication service provider 104 to facilitate mobile data and/or voice communications. The communication network 110 also includes a roaming node network 116 that is managed by a different communication service provider with which communication service provider 104 has a roaming coverage agreement.

The communication network 110, and the various included networks, can be implemented using any type of network topology and/or communication protocol, and can be represented or otherwise implemented as a combination of two or more networks. In this example system 100, the mobile phone 106 wirelessly communicates with the media content provider 102 via a mobile communication link 118. The mobile communication link 118 includes an underlying encrypted channel 120 between a SIM 108 of the mobile phone 106 and the roaming node network 116; an underlying encrypted channel 122 between the roaming node network 116 and the mobile operator network 114; and an underlying encrypted channel 124 between the mobile operator network 114 and the media content provider 102.

In the various embodiments described herein, over-the-air (OTA) refers to data transferred over the Mobile Network Operators mobile data network infrastructure (e.g. UMTS/GSM/CDMA2000) as opposed to connections made over non-MNO networks (e.g. public Wi-Fi hotspots). The mobile phone 106 can also communicate with the media content provider 102 via a network communication link, such as via the Internet, bypassing the communication service provider 104.

The communication service provider 104 stores or otherwise maintains various data, such as a database of registered devices 126 that includes an identifier of mobile phone 106 when registered with the communication service provider 104, such as for a cell phone data and service connection plan. A unique identifier can include any one or combination of a user identifier, a device identifier, a phone identifier, a phone number, and any other identifier that can be utilized to register and correlate billing a user for media content purchases and downloads from the media content provider 102.

The communication service provider 104 also includes an authentication service 128 to authenticate the mobile phone 106 for communications via the communication service provider and the mobile operator network 114. The communication service provider 104 also includes a content billing service 130 that can implement mobile phone billing for content payment. When a media asset or service is purchased and downloaded from the media content provider 102 to mobile phone 106, the media content provider determines a billing identifier 132 that is associated with the mobile phone 106, and communicates a charge 134 for the media asset to the communication service provider 104 that then bills a user associated with the mobile phone. The user that is associated with the mobile phone is billed for the media asset in a mobile phone service bill. In addition, the communication service provider 104 can be implemented with any number and combination of differing components as further described with reference to the example device shown in FIG. 4.

The media content provider 102 stores or otherwise maintains various data and media content, such as media assets 136 that can include any type of audio, video, and/or image media content received from any media content and/or data source. The media assets can include music files, videos, ringtones, television programs (or programming), advertisements, commercials, movies, video clips, data feeds, interactive games, network-based applications, and any other content or data that can be purchased and downloaded to mobile phone 106. The media content provider 102 includes one or more content servers 138 that are implemented to communicate, or otherwise distribute, the media assets 136 and/or other data to any number of various client devices when the media assets 136 are purchased and downloaded.

Various embodiments of security protocols for mobile operator networks, as described herein, provide that the mobile communication link 118 is a secure end-to-end connection between the mobile phone 106 and the media content provider 102 that traverses multiple mobile operator networks with different encryption policies. End-to-end security in compliance with crypto policy rules of the underlying network includes a message flow that establishes the secure, end-to-end connection. This enables a different or higher level protocol to conform to the crypto usage policy requirements of the underlying mobile network. Although various described embodiments of security protocols for mobile operator networks pertain to GSM based networks for mobile phones, the architecture and mechanisms described herein are also applicable and relevant to CDMA based cellular networks.

The system 100 illustrates an example of GSM SIM based authentication for roaming users. By way of the example, a roaming user (e.g., at mobile phone 106) can establish an initial connection with a visited or available mobile operator network (e.g., the roaming node network 116) that has different encryption requirements than the mobile operator network 114 that is managed by the communication service provider 104. In this described example, the visited roaming node network 116 supports authentication and integrity protection, but not encryption. The mobile phone 106 can query the SIM 108 for IMSI and send the IMSI value to the visited roaming node network 116 with which the communication service provider 104 has a roaming agreement.

The mobile operator that manages the roaming node network 116 can pass the IMSI to the communication service provider 104 via the mobile operator network 114 (e.g., the subscribers home mobile operator network). The communication service provider 104 can look up the key K that corresponds to the IMSI in a database. The K is also stored on the SIM 108 at mobile phone 106 where K is a long-term shared confidential value that is not revealed to the visited roaming node network 116. The communication service provider 104 can generate a random number, sign it using K, derive a new session key Kn (via K), and then pass all three values over a secure point-to-point link to enable the visited roaming node network to authenticate the SIM on its behalf.

The visited roaming node network 116 can send the random challenge to the mobile phone 106. The mobile phone can then pass the random challenge to the SIM 108 which uses K on the SIM card to sign the random challenge and derive the session key Kn. The mobile phone 106 can then forward the signed rand value to the visited roaming node network 116 which then compares it to a signed value sent from mobile operator network 114. If the values match, the SIM 108 proved knowledge of K and the visited roaming node network 116 proceeds to complete the connection establishment for the mobile phone 106. The value Kn′ is subsequently used to provide integrity protection and optionally encryption, depending on the encryption policy of the roaming node network 116. In various embodiments, the encryption and integrity protection is implemented via two different shared keys.

In various embodiments, the media content provider 102 also includes a security protocol service 140 that can be implemented as computer-executable instructions and executed by processors to implement the various embodiments and/or features of security protocols for mobile operator networks as described herein. The security protocol service 140 can receive a security policy request from the mobile phone to establish a security policy for end-to-end security of the mobile communication link 118 between the media content provider 102 and the mobile phone 106 for data communication security. The security policy request that is received from the mobile phone can include a region code that corresponds to the roaming node network 116. Alternatively, the region code that corresponds to the roaming node network 116 can be received from the communication service provider 104.

The security protocol service 140 can determine an encryption policy for the roaming node network 116 based on the region code that corresponds to the roaming node network. The security protocol service 140 can then initiate communication of a security policy response to the mobile phone. The security policy response includes the encryption policy that is utilized to establish the security policy for the end-to-end security of the mobile communication link 118 that is adaptable to security restrictions of the roaming node network. Alternatively or in addition, the media content provider 102 can receive the encryption policy for the roaming node network 116 from the mobile phone 106 and/or from the communication service provider 104 that maintains a cache of encryption policies 142 stored locally on the mobile phone or at the communication service provider, respectively.

Once a connection to the roaming node network 116 is established, the mobile phone 106 can proceed to establish an end-to-end connection to the media content provider 102. As part of setting up a security context between the mobile phone and the media content provider, the encryption policy used for an OTA connection is taken into account which can be implemented in a number of ways. The mobile phone 106 can obtain the region code from the network context and send it to the media content provider 102. Based on the region code, the media content provider can determine up the encryption policy and send the signed policy and region code back to the mobile phone. The policy and region code can be signed to prevent a man in the middle attack that alters the actual policy. In this example, the security policy of the roaming node network can allow for integrity protection. Thus, for end-to-end connection security, a cipher suite can be selected that conforms with the above policy (e.g., HMAC_SHA256 for integrity protection, and null encryption cipher).

As an alternative to implementing the above exchange as a separate message exchange, the region code and the signed response can be piggy-backed on the key exchange messages between the mobile phone 106 and the media content provider 102. Another approach is to implement a cache the encryption policies 142 for each region code locally on the mobile phone 106 and periodically push down any updates to the device. In another alternative, and before executing the key exchange phase, the media content provider 102 can obtain the region code directly from the communication service provider 104. This technique can be utilized when a mobile phone may not trusted to, in effect, assert the applicable crypto policy.

At the communication hop between the mobile operator network 114 and the media content provider 102, the communication service provider 104 can input or inject additional information or data into the communication stream (e.g., mobile communication link 118) between the mobile phone and the media content provider. For example, a billing identifier 132 that is associated with the SIM 108 at mobile phone 106 may be used by the media content provider 102 at a later time to report customer-initiated billable events to the communication service provider. In an embodiment, the media content provider 102 (also commonly referred to as a service provider) sends a challenge to the mobile phone 106 over the secure channel (e.g., mobile communication link 118). The mobile phone 106 then sends the challenge back to the media content provider 102 via the mobile operator network 114 that is managed by the communication service provider 104. The communication service provider 104 can then enrich the request with the billing identifier 132, or otherwise input additional data into the communication. This technique significantly reduces data communication exposure to vulnerabilities, particularly in a roaming scenario when the roaming node network 116 does not provide integrity protection.

Sending an unsecured message with a connection identifier from the mobile phone 106 to the media content provider 102 to enable the communication service provider 104 to add additional payload to the message (e.g., via an http header) opens the door for various forms of exploits (e.g., an attacker may inject a user session id from the attacker phone, ahead of the user, etc.). The various embodiments of security protocols for mobile operator networks as described herein can mitigate these attacks. For example, the media content provider 102 can send a challenge, such as a random number, to the mobile phone. The media content provider can store the challenge along with an expiration time in the connection record. The challenge may be sent as part of the key exchange or afterwards. The mobile phone 106 can sign the challenge with a private key or a session key that is established during the key exchange phase. The enriched payload can be accepted by the media content provider 102 if the signature on the challenge is valid and the message is sent before the expiration time associated with the challenge. Mounting an attack would be difficult with the above mechanism in place because the challenge is valid for a limited time window, and the valid response is sent over a SIM protected channel.

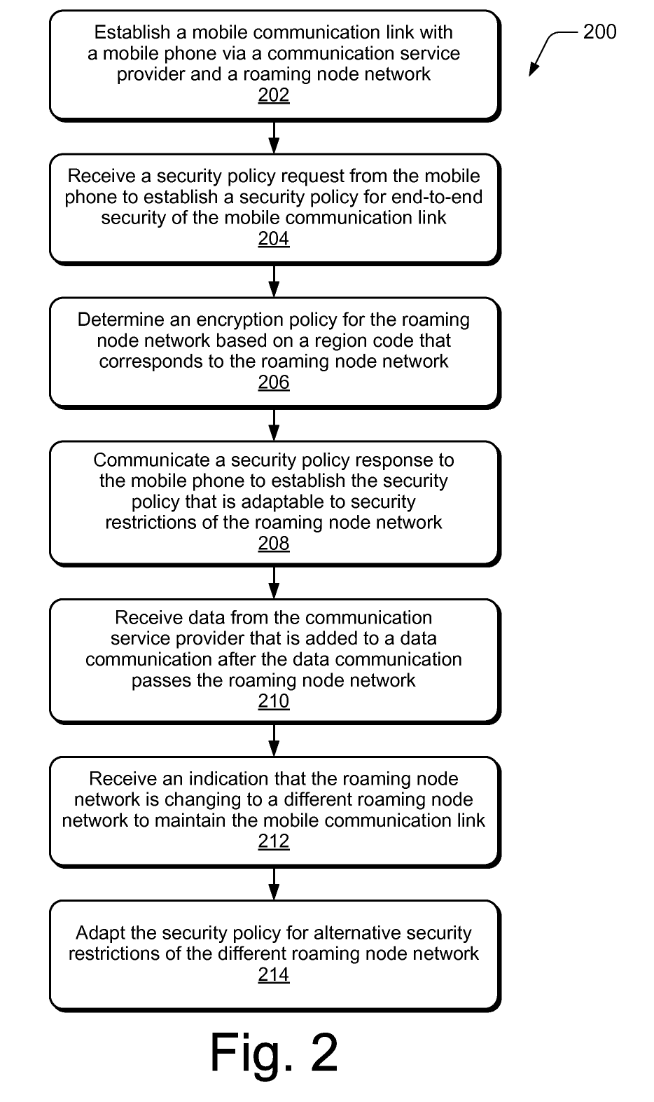

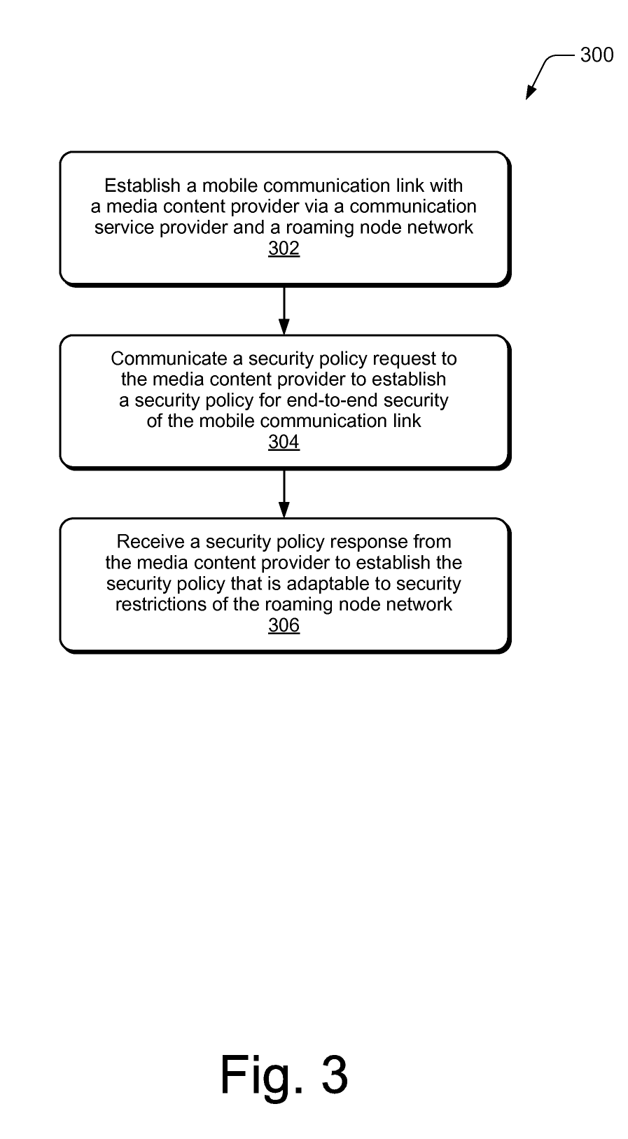

Example methods 200 and 300 are described with reference to respective FIGS. 2 and 3 in accordance with one or more embodiments of security protocols for mobile operator networks. Generally, any of the functions, methods, procedures, components, and modules described herein can be implemented using hardware, software, firmware, fixed logic circuitry, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 2 illustrates example method(s) 200 of security protocols for mobile operator networks at a mobile phone. The order in which the method blocks are described are not intended to be construed as a limitation, and any number of the described method blocks can be combined in any order to implement a method, or an alternate method.

At block 202, a mobile communication link is established with a mobile phone via a communication service provider and a roaming node network. For example, the media content provider 102 establishes the mobile communication link 118 with the mobile phone 106 via a communication service provider 104 with which the mobile phone is registered for mobile communications, and via the roaming node network 116 with which the communication service provider has a roaming service agreement.

At block 204, a security policy request is received from the mobile phone to establish a security policy for end-to-end security of the mobile communication link. For example, the security protocol service 140 at media content provider 102 receives a security policy request from the mobile phone 106 to establish a security policy for end-to-end security of the mobile communication link 118 between the media content provider 102 and the mobile phone 106 for data communication security. In an embodiment, the security policy request that is received from the mobile phone 106 includes a region code corresponding to the roaming node network 116. Alternatively or in addition, the region code that corresponds to the roaming node network 116 can be received from the communication service provider 104. In an implementation, the security policy request that is received from the mobile phone 106 is included with authentication data messages that are communicated between the mobile phone and the media content provider.

At block 206, an encryption policy for the roaming node network is determined based on the region code. For example, the security protocol service 140 at media content provider 102 determines an encryption policy for the roaming node network 116 based on the region code. Alternatively, the security policy request that is received from the mobile phone (at block 204) includes an encryption policy for the roaming node network 116, where the mobile phone 106 maintains a cache of encryption policies 142 stored locally on the mobile phone. Alternatively or in addition, the encryption policy is received from the communication service provider 104 that maintains the cache of encryption policies 142.

At block 208, a security policy response is communicated to the mobile phone to establish the security policy that is adaptable to security restrictions of the roaming node network. For example, the media content provider 102 communicates a security policy response to the mobile phone 106 to establish the security policy for the end-to-end security of the mobile communication link 118 that is adaptable to security restrictions of the roaming node network 116. In an embodiment, the security policy response includes the encryption policy determined at block 206.

At block 210, data is received from the communication service provider, where the data is added to a data communication after the data communication passes the roaming node network. For example, the media content provider 102 receives data (e.g., a billing identifier 132 that is associated with the mobile phone 106) from the communication service provider. The data is added to a data communication (e.g., in mobile communication link 118) by the communication service provider after the data communication passes the roaming node network 116. For example, the media content provider 102 securely receives the billing identifier 132 that is associated with the mobile phone 106 from the communication service provider via the mobile communication link 118.

At block 212, an indication is received that the roaming node network is changing to a different roaming node network to maintain the mobile communication link and, at block 214, the security policy is adapted for alternative security restrictions of the different roaming node network. For example, the security protocol service 140 at media content provider 102 receives an indication that the roaming node network 116 is changing to a different roaming node network to maintain the mobile communication link 118, such as when mobile communication is maintained while a user roams into a different network coverage area when using mobile phone 106. The security policy for the end-to-end security of the mobile communication link 118 is adapted for alternative security restrictions of the different roaming node network, such as by repeating blocks 204-208 to determine the encryption policy for the different roaming node network.

FIG. 3 illustrates example method(s) 300 of security protocols for mobile operator networks at a media content provider. The order in which the method blocks are described are not intended to be construed as a limitation, and any number of the described method blocks can be combined in any order to implement a method, or an alternate method.

At block 302, a mobile communication link is established with a media content provider via a communication service provider and a roaming node network. For example, the mobile phone 106 establishes the mobile communication link 118 with the media content provider 102 via a communication service provider 104 with which the mobile phone is registered for mobile communications, and via the roaming node network 116 with which the communication service provider has a roaming service agreement.

At block 304, a security policy request is communicated to the media content provider to establish a security policy for end-to-end security of the mobile communication link. For example, the mobile phone 106 communicates a security policy request to the media content provider 102 to establish a security policy for end-to-end security of the mobile communication link 118 between the media content provider 102 and the mobile phone 106 for data communication security.

At block 306, a security policy response is received from the media content provider to establish the security policy that is adaptable to security restrictions of the roaming node network. For example, the mobile phone 106 receives a security policy response from the media content provider 102 to establish the security policy for the end-to-end security of the mobile communication link 118 that is adaptable to security restrictions of the roaming node network 116.

FIG. 4 illustrates various components of an example device 400 that can be implemented as any type of mobile phone, computer device, and/or server device as described with reference to FIG. 1 to implement embodiments of security protocols for mobile operator networks. Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of security protocols for mobile operator networks. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 include a device manager 422 (e.g., a control application, software application, signal processing and control module, code that is native to a particular device, a hardware abstraction layer for a particular device, etc.). The device applications 418 also include any system components or modules to implement embodiments of security protocols for mobile operator networks. In this example, the device applications 418 include a security protocol service 424 that is shown as a software module and/or computer application. Alternatively or in addition, the security protocol service 424 can be implemented as hardware, software, firmware, or any combination thereof.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of security protocols for mobile operator networks have been described in language specific to features and/or methods, it is to be understood that the subject of the appended claims is not necessarily limited to the specific features or methods described. Rather, the specific features and methods are disclosed as example implementations of security protocols for mobile operator networks.

1. A method implemented by a computer device at a media content provider, the method comprising:
establishing a mobile communication link with a mobile phone via a communication service provider with which the mobile phone is registered for mobile communications, and via at least one roaming node network with which the communication service provider has a roaming service agreement;
receiving a security policy request from the mobile phone to establish a security policy for end-to-end security of the mobile communication link between the media content provider and the mobile phone for data communication security; and
communicating a security policy response to the mobile phone to establish the security policy for the end-to-end security of the mobile communication link that is adaptable to security restrictions of the roaming node network.

2. A method as recited in claim 1, wherein the security policy request that is received from the mobile phone includes a region code corresponding to the roaming node network.

3. A method as recited in claim 2, further comprising determining an encryption policy for the roaming node network based on the region code, and wherein the security policy response includes the encryption policy that is utilized to establish the end-to-end security of the mobile communication link.

4. A method as recited in claim 1, wherein the security policy request that is received from the mobile phone is included with authentication data messages that are communicated between the mobile phone and the media content provider.

5. A method as recited in claim 4, wherein the security policy request includes a region code corresponding to the roaming node network, the region code being included with the authentication data messages.

6. A method as recited in claim 5, further comprising determining an encryption policy for the roaming node network based on the region code, and wherein the security policy response is included with the authentication data messages.

7. A method as recited in claim 1, wherein the security policy request that is received from the mobile phone includes an encryption policy for the roaming node network, the mobile phone obtaining the encryption policy from a cache stored locally on the mobile phone.

8. A method as recited in claim 1, further comprising:
receiving a region code corresponding to the roaming node network, the region code being received from the communication service provider; and
determining an encryption policy for the roaming node network based on the region code, the security policy response including the encryption policy that is utilized to establish the end-to-end security of the mobile communication link.

9. A method as recited in claim 1, further comprising:
receiving an indication that the roaming node network is changing to a different roaming node network to maintain the mobile communication link; and
adapting the security policy for the end-to-end security of the mobile communication link for alternative security restrictions of the different roaming node network.

10. A method as recited in claim 1, further comprising:
communicating a challenge to the mobile phone via the mobile communication link that is secure based on the security policy, the mobile communication link including the roaming node network and a mobile operator network that is managed by the communication service provider; and
receiving the challenge back from the mobile phone via the mobile operator network and the communication service provider, the challenge including data added by the communication service provider.

11. A method as recited in claim 10, wherein the data received from the communication service provider is a billing identifier that is associated with the mobile phone, the billing identifier being securely received from the communication service provider via the mobile communication link.

12. A method implemented by a mobile phone, the method comprising:
establishing a mobile communication link with a media content provider via a communication service provider with which the mobile phone is registered for mobile communications, and via at least one roaming node network with which the communication service provider has a roaming service agreement;
communicating a security policy request to the media content provider to establish a security policy for end-to-end security of the mobile communication link between the media content provider and the mobile phone for data communication security; and
receiving a security policy response from the media content provider to establish the security policy for the end-to-end security of the mobile communication link that is adaptable to security restrictions of the roaming node network.

13. A method as recited in claim 12, wherein the security policy request includes a region code that corresponds to the roaming node network, and wherein the security policy response includes an encryption policy that the media content provider determines based on the region code.

14. A method as recited in claim 12, wherein the security policy request and the security policy response are included with authentication data messages that are communicated between the mobile phone and the media content provider.

15. A mobile communication system, comprising:
a media content provider configured to establish a mobile communication link with a mobile phone via a communication service provider with which the mobile phone is registered for mobile communications, and via at least one roaming node network with which the communication service provider has a roaming agreement;
a security protocol service implemented by a computer device at the media content provider, the security protocol service configured to:
receive a security policy request from the mobile phone to establish a security policy for end-to-end security of the mobile communication link between the media content provider and the mobile phone for data communication security;
determine an encryption policy for the roaming node network based on a region code that corresponds to the roaming node network; and
initiate communication of a security policy response to the mobile phone, the security policy response including the encryption policy that is utilized to establish the security policy for the end-to-end security of the mobile communication link that is adaptable to security restrictions of the roaming node network.

16. A mobile communication system as recited in claim 15, wherein the security policy request and the security policy response are included with authentication data messages that are communicated between the mobile phone and the media content provider.

17. A mobile communication system as recited in claim 15, wherein the security protocol service is further configured to receive the encryption policy for the roaming node network from the mobile phone that maintains a cache of encryption policies stored locally on the mobile phone.

18. A mobile communication system as recited in claim 15, wherein the security protocol service is further configured to receive the region code that corresponds to the roaming node network from the communication service provider.

19. A mobile communication system as recited in claim 15, wherein the security protocol service is further configured to:
receive an indication that the roaming node network is changing to a different roaming node network to maintain the mobile communication link; and
adapt the security policy for the end-to-end security of the mobile communication link for alternative security restrictions of the different roaming node network.

20. A mobile communication system as recited in claim 15, wherein the media content provider is further configured to:
communicate a challenge to the mobile phone via the mobile communication link that is secure based on the security policy, the mobile communication link including the roaming node network and a mobile operator network that is managed by the communication service provider; and
receive the challenge back from the mobile phone via the mobile operator network and the communication service provider, the challenge including data added by the communication service provider.
